(19) United States
(12) Patent Application Publication
(10) Pub. No.: US 2009/0049160 A1
(43) Pub. Date: Feb. 19, 2009

(54) System and Method for Deployment of a Software Image

(75) Inventors: Jacob Cherian, Austin, TX (US); Pankaj Gupta, Round Rock, TX (US); Gaurav Chawla, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/838,423

(22) Filed: Aug. 14, 2007

(51) Int. Cl. G06F 15/177

(52) U.S. Cl. 709/222; 713/2

(57) ABSTRACT

Systems and methods for deployment of a software image are disclosed. A system for deployment of a software image may include a host communicatively coupled to a first logical unit including a generic boot image and a software image, and to a second logical unit communicatively coupled to the first logical unit. The host may be operable to (a) boot from the generic boot image via a transport protocol; (b) copy the software image from the first logical unit to the second logical unit via the transport protocol; and (c) boot from the software image via the transport protocol.

### TECHNICAL FIELD

The present disclosure relates in general to data storage, and more particularly to a system and method for deployment of a software image.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput, and/or capacity. In operation, one or more storage resources disposed in an array of storage resources may appear to an operating system as a single logical storage unit or “logical unit.” Implementations of storage resource arrays can range from a few storage resources disposed in a server chassis, to hundreds of storage resources disposed in one or more separate storage enclosures.

In certain applications, one or more information handling systems may boot their operating systems remotely from a logical unit remotely coupled to the information handling system via a network. Configuring remote booting capability for a number of information handling systems may require management and configuration of the information handling systems, the network, and the logical units, as well as deployment of the boot images to allow the various information handling systems to boot from a remote logical unit.

Conventional approaches to software image deployment and remote boot of an information handling system often require a preboot execution environment (PXE) application running on the information handling system. The PXE application may boot the information handling system (using its network transmission protocol (PXE protocol)), configure the information handling system, and, deploy a software image associated with the information handling system to a logical unit coupled to the information handling system via a network. To deploy the software image, the transmission protocol of the information handling system may need to be configured to communicate via the Internet Small Computer System Interface (iSCSI) protocol. After the software image is deployed, using the iSCSI protocol, the information handling system may then boot from its associated software image. This conventional approach has many disadvantages. For example, using the conventional approach, the transmission protocol used by an information handling system may require configuration of network ports associated with the information handling system for PXE protocol and iSCSI protocol. Alternatively, the transmission protocol used by an information handling system may require reconfiguration of a network port associated with the information handling system from PXE protocol to iSCSI protocol, adding management complexity.

### SUMMARY

In accordance with the teachings of the present disclosure, the disadvantages and problems associated the software image deployment process have been substantially reduced or eliminated. In a particular embodiment, a method may include booting from a generic boot image, copying a software image, and booting from the software image, all using the same transport protocol.

In accordance with one embodiment of the present disclosure, a system for the deployment of a software image may include a host communicatively coupled to a first logical unit including a generic boot image and a software image, and to a second logical unit communicatively coupled to the first logical unit. The host may be operable to (a) boot from the generic boot image via a transport protocol;

(b) copy the software image from the first logical unit to the second logical unit via the transport protocol; and (c) boot from the software image via the transport protocol.

In accordance with another embodiment of the present disclosure, a method for the deployment of a software image is provided. The method may include a host booting from a generic boot image located on a first logical unit via a transport protocol. The host may also copy a software image located on the first logical unit to the second logical unit via the transport protocol. In addition, the host may boot from the software image via the transport protocol.

In accordance with a further embodiment of the present disclosure, an information handling system may include a processor, a memory communicatively coupled to the processor, and a network port communicatively coupled to the processor and the memory, and interfacing with a storage array. The processor may be operable to communicate via the network port with the storage array to (a) boot the information handling system from a generic boot image located on a first logical unit disposed in the storage array via a transport protocol; (b) copy a software image located on the first logical unit to a second logical unit disposed in the storage array via a transport protocol; and (c) boot the information handling system from the software image via a transport protocol.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a conventional system for deploying a software boot image;

FIG. 2 illustrates a block diagram of an example system for deploying a software image, in accordance with the teachings of the present disclosure; and

FIG. 3 illustrates a flow chart of a method for deploying a software image, in accordance with the teachings of the present disclosure.

### DETAILED DESCRIPTION

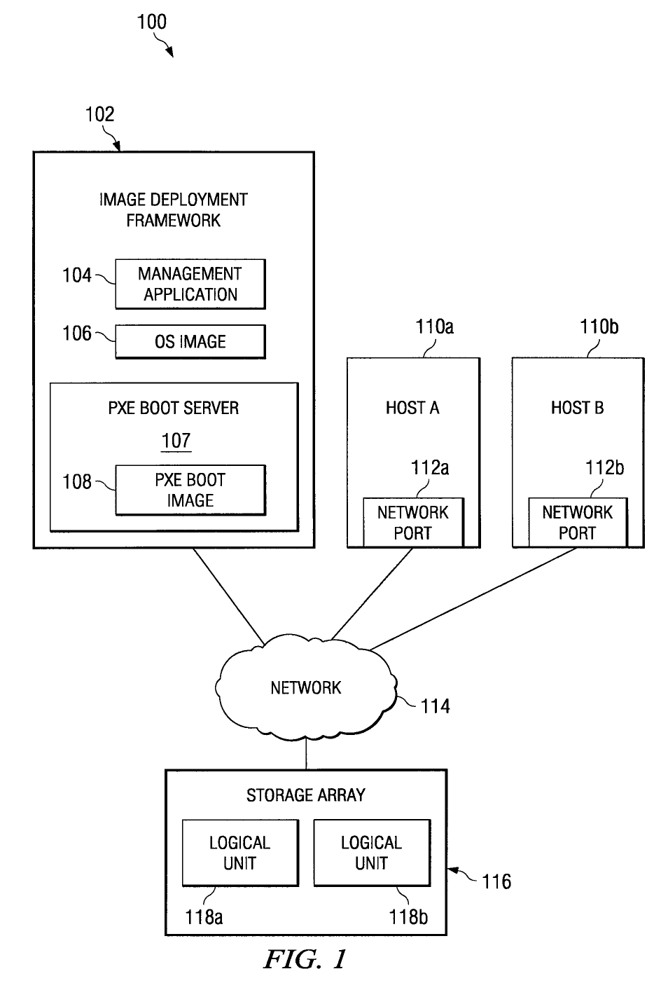

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

As discussed above, an information handling system may be communicatively coupled to an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 1 illustrates a block diagram of conventional system 100 for deploying a software boot image. As depicted in FIG. 1, system 100 includes an image deployment framework 102, one or more hosts 110, a storage array 116, and a network 114 that communicatively couples image deployment framework 102, hosts 110, and storage array 116. Image deployment framework 102 includes a management application 104, an operating system (OS) image 106, and a PXE boot service 107 including a PXE boot image 108. Each host 110 may include an associated network port 112, which provides an interface between each host 110 and network 114. In addition, storage array 116 includes one or more logical units 118, which may be operable to store data and/or instructions, e.g., software for use on hostss 110.

In operation, system 100 may be useful to deploy a copy of OS image 106 to a logical unit 118 for use on a host 110. To illustrate, network port 112a of host 110a may be configured to communicate via PXE protocol, in order to boot from PXE boot image 108 located on PXE boot server 108. Host 110a may then boot from PXE boot image 108. In order to initiate the deployment of OS image 106 to a logical unit 118, OS image 106 may first need to be written to host 110a, then copied from host 110a to a logical unit 118, e.g., logical unit 118a. The copying of OS image 106 to host 110a may require use of a transport protocol compatible with imaging tools available within PXE boot image 108, such as network file system (NFS) protocol or server message block (SMB) protocol. After OS image 106 is copied to host 110a, network port 112a may need to be reconfigured to a protocol (e.g., iSCSI) that supports the copying of OS image 106 from host 110a to a logical unit 118. Network port 112a may then be configured to boot using iSCSI, and host 110a may communicate over network 114 to storage array 116, where host 110a may reboot from a copy of the OS image stored on logical unit 118a.

As mentioned above, the conventional approach depicted in FIG. 1 has numerous disadvantages. For example, after host 110a is booted using PXE-compatible protocols, network port 112a must be reconfigured from a PXE-compatible protocol to another network protocol (e.g., iSCSI) in order to complete the deployment of OS image 106 to logical unit 118a. In addition, after OS image 106 is copied, network 112a must be reconfigured for iSCSI boot so that it may boot from the copy of OS image 106 on logical unit 118a after reboot. Thus, various reconfigurations of network port 112a may cause management complexity as well as undesired latency in system 100.

The other option is to enable the network port to support both the PXE-compatible protocol and protocol over which the storage resource is accessed. The disadvantage here is the complexity of the solution and the additional code needed to support both protocols.

To reduce or eliminate these disadvantages, the method and systems described herein may be used. In essence, the present disclosure provides for an approach to deployment of software images that does not require various reconfigurations of network port 112a or require network port 112a to support multiple protocols.

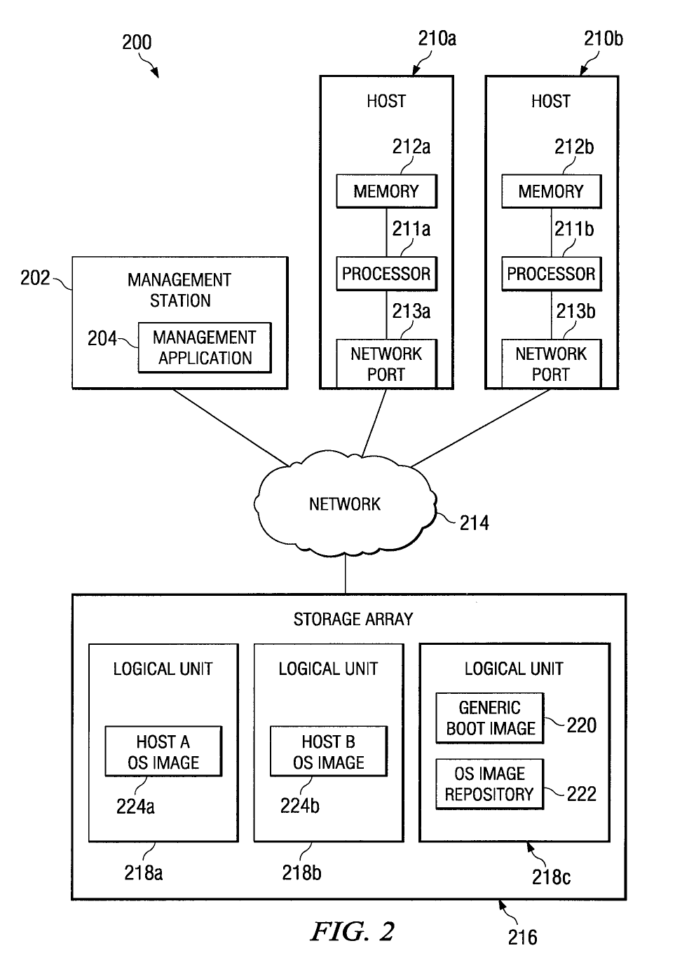

FIG. 2 illustrates a block diagram of an example system 200 for deploying a software image, in accordance with the teachings of the present disclosure. As depicted in FIG. 2, system 200 may comprise a management station 202, one or more hosts 210, a network 214, and a storage array 216. Management station 202 may comprise an information handling system, and may generally be operable to allow a user, e.g., a network administrator and/or information technology professional, to manage, configure, and/or monitor hosts 210, network 214, and storage array 216. In certain implementations, management station 202 may comprise a management application 204, e.g., a simple network management protocol (SNMP) compliant application operable to manage various components of system 200. In other implementations, system 200 may not include a dedicated management station 202, and management of system 200 may be provided by one or more other components of system 200 (e.g., one or more of hosts 210).

Each host 210 may comprise an information handling system and may generally be operable, via an associated network port 213, to read data from and/or write data to one or more logical units 218 disposed in storage array 216. In certain embodiments, one or more of hosts 210 may be a server. As depicted in FIG. 2, each host may comprise a processor 211, memory 212 communicatively coupled to processor 211, and network port 213 communicatively coupled to processor 211.

Each processor 211 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 211 may interpret and/or execute program instructions and/or process data stored in memory 212 and/or another component of host 210.

Each memory 212 may be communicatively coupled to its associated processor 211 and may comprise any system, device, or apparatus operable to retain program instructions or data for a period of time. Memory 212 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to host 210 is turned off.

Network port 213 may be any suitable system, apparatus, or device operable to serve as an interface between host 210 and network 214. Network port 213 may enable host 210 to communicate over network 214 using any suitable transmission protocol and/or standard, including without limitation all transmission protocols and/or standards enumerated below with respect to the discussion of network 214.

Although system 200 is depicted as having two hosts 210, system 200 may include any number of hosts 210.

Network 214 may be a network and/or fabric configured to couple hosts 210 to storage array 216. In certain embodiments, network 214 may allow hosts 210 to connect to logical units 218 disposed in storage array 216 such that the logical units 218 appear to the hosts 210 as locally attached storage resources. In the same or alternative embodiments, network 214 may include a communication infrastructure, which provides physical connections, and a management layer, which organizes the physical connections, logical units 218 of storage array 216, and hosts 210. In the same or alternative embodiments, network 214 may allow block I/O services and/or file access services to logical units 218 disposed in storage array 210. Network 214 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 214 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof. Network 214 and its various components may be implemented using hardware, software, or any combination thereof.

As depicted in FIG. 2, storage array 216 may comprise one or more logical units 218, and may be communicatively coupled to hosts 210 and/or network 214, in order to facilitate communication of data between hosts 210 and logical units 218. Logical units 218 may each be made up of one or more hard disk drives, magnetic tape libraries, optical disk drives, magneto-optical disk drives, compact disk drives, compact disk arrays, disk array controllers, and/or any other systems, apparatuses, or devices operable to store data. Although the embodiment shown in FIG. 2 depicts system 200 having three logical units 218, it is understood that storage array 216 may have any number of logical units 218.

Although FIG. 2 depicts that hosts 210 are communicatively coupled to storage array 216 via network 214, it is understood that one or more host 210 may be communicatively coupled to one or more logical units 218 without network 214 or other similar network. For example, in certain embodiments, one or more logical units 218 may be directly coupled and/or locally attached to one or more hosts 210.

In some embodiments, storage array 216 may include one or more storage enclosures configured to hold and power one or more storage resources comprising logical units 218. In such embodiments, such storage enclosures may be communicatively coupled to host 210 and/or network 214, in order to facilitate communication of data between host 210 and logical units 218. In addition, although FIG. 2 depicts a single storage array 216 comprising logical units 218, logical units 218 may be disposed in one or more storage arrays 216.

As depicted in FIG. 2, logical unit 218c of storage array 216 may comprise a generic boot image 220 and an operating system (OS) image repository 222. Generic boot image 220 may comprise a pre-operating system environment that may enable a host 210 to boot with minimal, but sufficient, resources to allow it to deploy an OS image to a logical unit 218, in accordance with the present disclosure. Generic boot image 220 may be accessible from a host 210 using standard commands (e.g., SCSI commands), thereby allowing host 210 to boot. OS image repository 222 may comprise one or more software images, e.g., operating system images, to be deployed to one or more logical units 218.

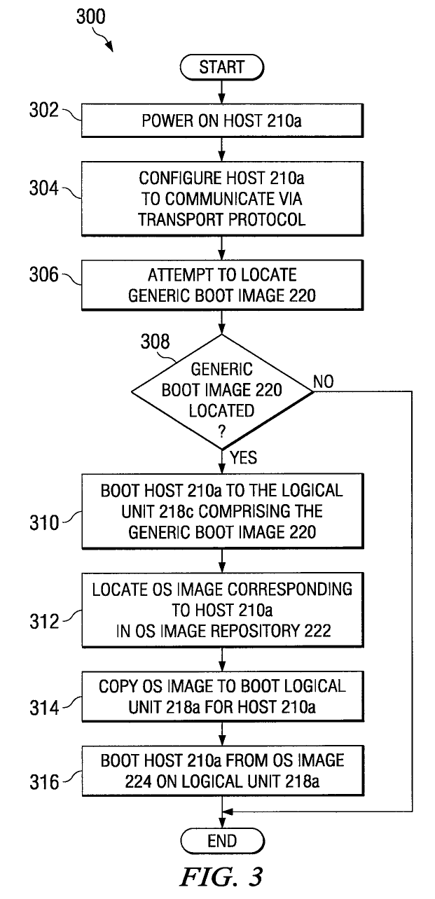

In operation, system 200 may permit deployment of one or more software images from OS image repository 222 to one or more logical units 218 associated with particular hosts 210. For example, as discussed below with respect to FIG. 3, OS images 224a and/or 224b may be deployed to logical unit 218a and/or logical unit 218b, as shown in FIG. 2.

FIG. 3 illustrates a flow chart of a method 300 for deploying a software image, in accordance with the teachings of the present disclosure. In one embodiment, method 300 includes locating an OS image associated with host 210, and deploying the OS image to a logical unit 218 associated with the host 210.

According to one embodiment, method 300 preferably begins at step 302. As noted above, teachings of the present disclosure may be implemented in a variety of configurations of system 200. As such, the preferred initialization point for method 300 and the order of the steps 302-316 comprising method 300 may depend on the implementation chosen.

In addition, although method 300 is described below with respect to the deployment by host 210a of OS image 224a to logical unit 218a, system 200 and method 300 may be applied to deployment of any OS image by any host 210 onto any logical unit 218 disposed within storage array 216. Furthermore, although method 300 describes deployment of an OS image, system 200 and method 300 may be used to deploy any type of data image, e.g., an application program.

At step 302, host node 210a and the components comprising host node 210a may power on. At step 304, management application 204, host 210a, and/or another component of system 200 may configure network port 213a to communicate via a particular transport protocol, e.g., iSCSI. At step 306, host 210a may communicate via the transport protocol to attempt to locate generic boot image 220. For example, an ISCSI initiator component of host 210a may use Internet Storage Name Service (iSNS) to attempt to locate the storage array 216 comprising the generic boot image 220. As another example, host 210a may attempt to locate the storage array 216 comprising the generic boot image 220 using dynamic host configuration protocol (DHCP). In the same or alternative embodiments, host 210a may issue an appropriate SCSI command (e.g., INQUIRY) in an attempt to locate generic boot image 220 within storage array 216.

At step 308, host 210a or another component of system 200 may determine whether or not generic boot image 220 has been located. As an example, if a generic boot image 220 exists, the logical unit 218c comprising generic boot image 220 may respond to an INQUIRY and/or other SCSI command issued by host 210a that indicates that it comprises generic boot image 220. If, at step 308, generic boot image 220 is located, method 300 may proceed to step 210. Otherwise, if generic boot image 220 cannot be located, method 300 may end.

After generic boot image 220 is located, host 210a may be booted from logical unit 218c comprising the generic boot image 220. Generic boot image 220 may enable sufficient functionality in host 210a to allow it to deploy an OS image, in accordance with the present disclosure.

At step 312, host 210a and/or another component of system 200 may locate, within OS image repository 222, an OS image corresponding to host 210a. For example, host 210a may use SCSI commands to send host 210a specific information to image repository 222. Such information can then be used by image repository 222 to create and/or identify an OS image specific to host 210a.

At step 314, host 210a may issue commands via its network port 213a to copy the located OS image from image repository 222 to logical unit 218a (or another logical unit) associated with host 210a. As depicted in FIG. 2, after completion of step 314, logical unit 218a may comprise OS image 224a, which may be a copy of the OS image copied from OS image repository 222.

At step 316, host 210a may boot from OS image 224a on logical unit 218a. After completion of step 316, method 300 may end. Thus, as a result of completion of method 300 as described above, OS image 224a associated with host 210a may be deployed to a logical unit 218a associated with host 210a.

Although FIG. 3 depicts the singular deployment of OS image 224a to logical unit 218a, steps identical or similar to those of method 300 may be used in connection with the deployment of other OS images associated with hosts 210 to logical units 218. For example, methods similar to those discussed above could be used to deploy an OS image 224b associated with host 210b to logical unit 218b, as shown in FIG. 2.

Although FIG. 3 discloses a particular number of steps to be taken with respect to method 300, method 300 may be executed with more or fewer steps than those depicted in FIG. 3. Method 300 may be implemented using system 200 or any other system operable to implement method 300. In certain embodiments, method 300 may be implemented partially or fully in software embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or storage.

Using the methods and systems disclosed herein, problems associated conventional approaches to data storage and backup power may be improved reduced or eliminated. For example, because the methods and systems disclosed may allow for deployment of a OS image for a host, without the need to reconfigure the communication protocol and/or standard of the host, latency and management complexity associated with conventional deployment methods may be reduced.

Although the present disclosure has been described in detail, it should be understood that various changes, substitutions, and alterations can be made hereto without departing from the spirit and the scope of the invention as defined by the appended claims.

What is claimed is:

1. A system for deploying a software image, comprising:
a host communicatively coupled to a first logical unit including a generic boot image and a software image, and to a second logical unit communicatively coupled to the first logical unit, the host operable to:
boot from the generic boot image via a transport protocol;
copy the software image from the first logical unit to the second logical unit via the transport protocol; and
boot from the software image via the transport protocol.

2. A system according to claim 1, wherein the transport protocol comprises Internet Small Computer System Interface (iSCSI) protocol.

3. A system according to claim 1, wherein the transport protocol comprises a protocol selected from the group consisting of: Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), and integrated drive electronics (IDE).

4. A system according to claim 1, wherein the first logical unit includes an image repository including the software image and one or more other software images.

5. A system according to claim 4, the at least one host further operable to locate within the image repository the software image to be copied.

6. A system according to claim 1, wherein the one or more software images comprise an operating system.

7. A system according to claim 1, wherein:
the at least one host comprises a network port, and
the at least one host is further operable to configure the network port to communicate with the first logical unit and the second logical unit via the transport protocol.

8. A method for the deployment of a software image comprising:
a host booting from a generic boot image located on a first logical unit via a transport protocol;
the host copying a software image located on the first logical unit to the second logical unit via the transport protocol; and
the host booting from the software image via the transport protocol.

9. A method according to claim 8, wherein the transport protocol comprises Internet Small Computer System Interface (iSCSI) protocol.

10. A method according to claim 8, wherein the transport protocol comprises a protocol selected from the group consisting of: Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE).

11. A method according to claim 8, further comprising the host locating, via the transport protocol, the software image within an image repository including the software image and one or more other software images.

12. A method according to claim 8, wherein the one or more software images comprise an operating system.

13. A method according to claim 8, further comprising configuring a network port disposed in the at least one host to communicate via the transport protocol.

14. An information handling system comprising:
a processor;
a memory communicatively coupled to the processor; and
a network port communicatively coupled to the processor and the memory, and interfacing with a storage array;
the processor operable to communicate via the network port with the storage array to:
boot the information handling system from a generic boot image located on a first logical unit disposed in the storage array via a transport protocol;
copy a software image located on the first logical unit to a second logical unit disposed in the storage array via a transport protocol; and
boot the information handling system from the software image via a transport protocol.

15. An information handling system according to claim 14, wherein the transport protocol comprises Internet Small Computer System Interface (iSCSI) protocol.

16. An information handling system according to claim 14, wherein the transport protocol comprises a protocol selected from the group consisting of: Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), and integrated drive electronics (IDE).

17. An information handling system according to claim 14, wherein the first logical unit comprises an image repository comprising the software image and one or more other software images.

18. An information handling system according to claim 17, the at least one host further operable to locate within the image repository the software image to be copied via the transport protocol.

19. An information handling system according to claim 14, wherein the one or more software images comprise an operating system.

20. An information handling system according to claim 14, the processor further operable to configure the network port to communicate with the first logical unit and the second logical unit via the transport protocol.
